(19) United States
(12) Patent Application Publication
(10) Pub. No.: US 2007/0233760 A1
(43) Pub. Date: Oct. 4, 2007

(54) 3:2 Bit compressor circuit and method

(76) Inventors: Sanu Mathew, Hillsboro, OR (US); Ram Krishnamurthy, Portland, OR (US); Zheng Guo, Berkeley, CA (US)

Correspondence Address: BUCKLEY, MASCHOFF & TALWALKAR LLC, 50 LOCUST AVENUE, NEW CANAAN, CT, 06840, US

(21) Appl. No.: 11/392,070

(22) Filed: Mar. 29, 2006

(51) Int. Cl. G06F 7/00; G06F 15/00

(52) U.S. Cl. 708/204

(57) ABSTRACT

A circuit to convert three input bits (A, B and C) to a redundant format may include a first block with at least one transmission gate, and a second block with at least one static mirror. The first block may receive the three bits and output a sum bit, and the second block may receive the three bits and output a carry bit.

### BACKGROUND

Compressors are important circuits within processor functional blocks. For example, a floating-point processing core often generates a significant percentage of a processor's overall heat output, and a floating-point multiplier generates a significant percentage of the heat generated by the floating-point processing core. A partial product reduction unit of the floating-point processing multiplier, which is composed primarily of compressors, generates a significant percentage of the heat generated by the floating-point multiplier.

In addition, the processing speed of a conventional multiplier depends substantially upon the speed of the compressors within its partial product reduction unit. The compressors within a multiplier may therefore greatly influence the speed and the power-efficiency of the multiplier and of a processor including the multiplier. Hence, compressor designs providing suitable speed and power efficiency are desired.

### BRIEF DESCRIPTION OF THE DRAWINGS

FIG. 1 is a block diagram of a multiplier according to some embodiments.

FIG. 2 is a block diagram of a compressor according to some embodiments.

FIG. 3 is a flow diagram according to some embodiments.

FIG. 4 is a schematic diagram of a sum block according to some embodiments.

FIG. 5 is a schematic diagram of a carry block according to some embodiments.

FIG. 6 is a block diagram of a system according to some embodiments.

### DETAILED DESCRIPTION

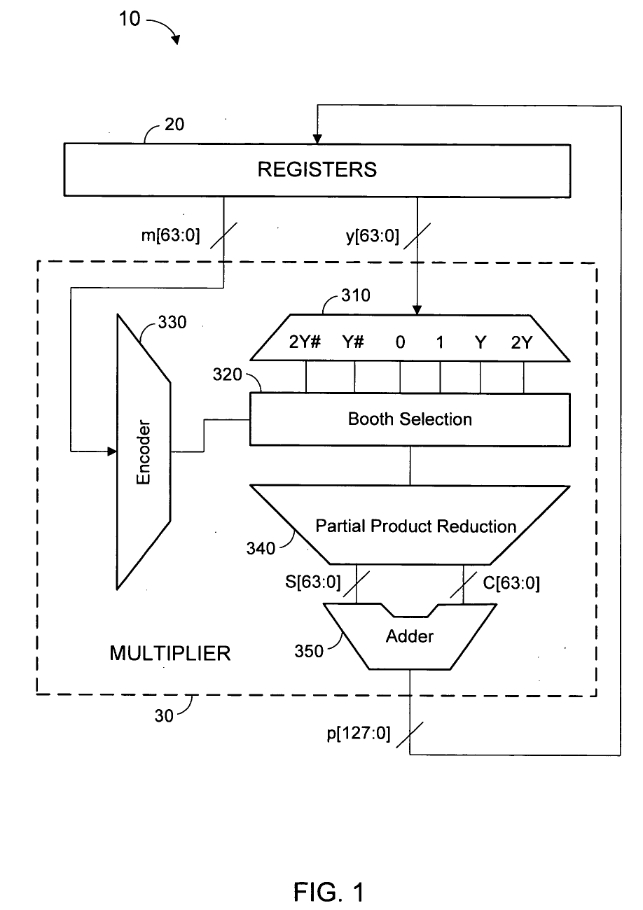

FIG. 1 illustrates system 10 according to some embodiments. System 10 includes registers 20 storing 64-bit muliplicand (y) and 64-bit multiplier (m). System 10 also includes multiplier 30 for multiplying y by m to generate a 128-bit result (p). Multiplier 30 therefore comprises a 64-bit×64-bit multiplier, but embodiments are not limited thereto. Moreover, embodiments may be implemented within any suitable system and are not limited to a multiplier.

Multiplier 30 includes multiplexer 310 to output various 2's complement representations of the multiplicand. Booth selection unit 320 selects and outputs one of the representations as a partial product based on the multiplier as encoded by encoder 330. Each partial product output from Booth selection unit 320 is received and summed by partial product reduction unit 340.

Partial product reduction unit 340 may comprise a partial product summation tree to sum the partial products into a product of the multiplier and the multiplicand. The product is represented in a redundant form. For example, the product may be represented by 128 Sum bits and 128 Carry bits. Accordingly, adder 350 receives the Carry bits and Sum bits and converts the received bits into a 128-bit binary number (p).

Partial product reduction unit 340 may comprise a tree including 3:2 compressors. Embodiments may be used in conjunction with any currently- or hereafter-known tree architecture. Each of the 3:2 compressors receives three input bits and outputs a Sum bit and a Carry bit based on the three input bits.

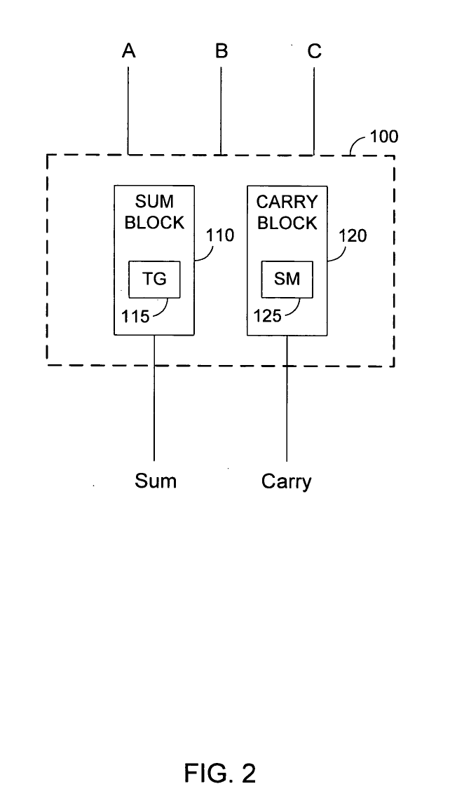

FIG. 2 is a block diagram of a 3:2 compressor according to some embodiments. As shown, compressor 100 comprises Sum block 110 and Carry block 120. Sum block 110 receives three input bits A, B and C and outputs a Sum bit based thereon. The Sum bit may represent the result of the logical operation A XOR B XOR C. Carry block 120, in contrast, receives input bits A, B and C and outputs a Carry bit based thereon.

Sum block 110 comprises transmission gate 115 and Carry block comprises static mirror 125. According to some embodiments, transmission gate 115 is particularly suitable for performing an XOR logical operation. Static mirror 125, on the other hand, may provide fast production of the Carry bit. Static mirror 125 may also or alternatively facilitate routing of the circuit elements of Carry block 120. includes multiplier 30 for multiplying y by m to generate a 128-bit result (p). Multiplier 30 therefore comprises a 64-bit×64-bit multiplier, but embodiments are not limited thereto. Moreover, embodiments may be implemented within any suitable system and are not limited to a multiplier.

Multiplier 30 includes multiplexer 310 to output various 2's complement representations of the multiplicand. Booth selection unit 320 selects and outputs one of the representations as a partial product based on the multiplier as encoded by encoder 330. Each partial product output from Booth selection unit 320 is received and summed by partial product reduction unit 340.

Partial product reduction unit 340 may comprise a partial product summation tree to sum the partial products into a product of the multiplier and the multiplicand. The product is represented in a redundant form. For example, the product may be represented by 128 Sum bits and 128 Carry bits. Accordingly, adder 350 receives the Carry bits and Sum bits and converts the received bits into a 128-bit binary number (p).

Partial product reduction unit 340 may comprise a tree including 3:2 compressors. Embodiments may be used in conjunction with any currently- or hereafter-known tree architecture. Each of the 3:2 compressors receives three input bits and outputs a Sum bit and a Carry bit based on the three input bits.

FIG. 2 is a block diagram of a 3:2 compressor according to some embodiments. As shown, compressor 100 comprises Sum block 110 and Carry block 120. Sum block 110 receives three input bits A, B and C and outputs a Sum bit based thereon. The Sum bit may represent the result of the logical operation A XOR B XOR C. Carry block 120, in contrast, receives input bits A, B and C and outputs a Carry bit based thereon.

Sum block 110 comprises transmission gate 115 and Carry block comprises static mirror 125. According to some embodiments, transmission gate 115 is particularly suitable for performing an XOR logical operation. Static mirror 125, on the other hand, may provide fast production of the Carry bit. Static mirror 125 may also or alternatively facilitate routing of the circuit elements of Carry block 120.

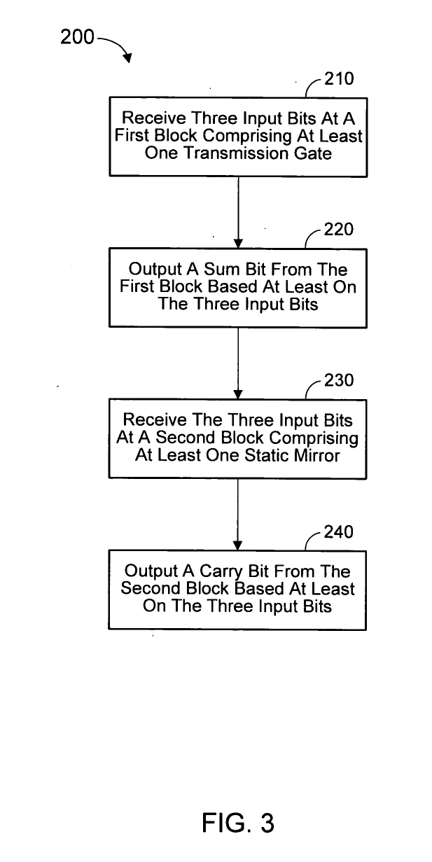

FIG. 3 is a flow diagram of method 200 to compress three input bits to a Carry bit and a Save bit according to some embodiments. Method 200 may be executed by, for example, systems such as systems 10 and/or 100. Any of the methods described herein may be performed by hardware, software (including microcode), or a combination of hardware and software.

Initially, at 210, three input bits are received at a first block. The first block includes at least one transmission gate. The first block may be an element of any functional unit, including but not limited to partial product reduction unit 340 of multiplier 30. In some embodiments, the first block comprises Sum block 110 of compressor 100. As mentioned above, Sum block 110 includes transmission gate 115.

A Sum bit is output from the first block at 220. The Sum bit is output based at least on the three input bits. FIG. 2 illustrates one example of outputting a Sum bit from a first block based on three input bits. According to the FIG. 2 example, the Sum bit is equal to A XOR B XOR C, wherein A, B and C are the three input bits.

At 230, the three input bits are received at a second block. The second block includes at least one transmission gate, and the three input bits may be received by the second block substantially simultaneously with reception of the three input bits by the first block at 210. The second block may comprise Carry block 120 including static mirror 125 as shown in FIG. 2.

A Carry bit is output from the second block at 240 based at least on the three input bits. The Carry bit and/or the output Sum bit may be input to a “downstream” 3:2 compressor that itself includes a Sum block and a Carry block as described above. In some embodiments, the Carry bit is output to adder 350 along with 127 other Carry bits. Adder 350 may propagate the Carry bits and, along with 128 received Sum bits, generate a final product.

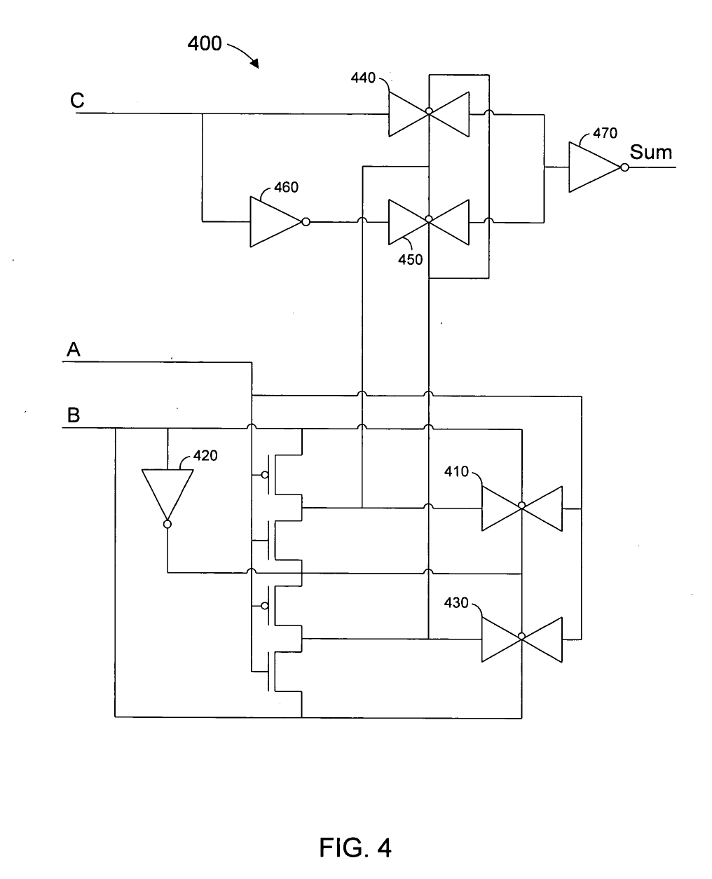

FIG. 4 is a schematic diagram of Sum block 400 according to some embodiments. Sum block 400 is to receive three input bits (e.g., A, B and C) and output a Sum bit (e.g., A XOR B XOR C), and includes a transmission gate. Sum block 400 may be used to implement Sum block 110 of compressor 100. Sum block 400 itself may be implemented using any systems to implement circuit elements (e.g., semiconductors, discrete elements, software) that are or become known.

FIG. 4 shows transmission gate 410 comprising an inverted control node to receive input bit B, a non-inverted control node to receive B# from inverter 420, and an output to receive input bit A. Transmission gate 430 includes an inverted control node coupled to the non-inverted control node of transmission gate 410 and therefore to also receive B#, a second non-inverted control node to receive input bit B, and an output connected to the output of transmission gate 410.

Transmission gate 440 includes an input to receive input bit C, and an output connected to the output of transmission gate 450. Transmission gate 450, in this regard, includes an input to receive C# from inverter 460, an inverted control node connected to the non-inverted control node of transmission gate 440, and a non-inverted control node connected to the inverted control node of transmission gate 440. The outputs of transmission gate 440 and transmission gate 450 are connected to an input of inverter 470, which is to output the Sum bit as shown.

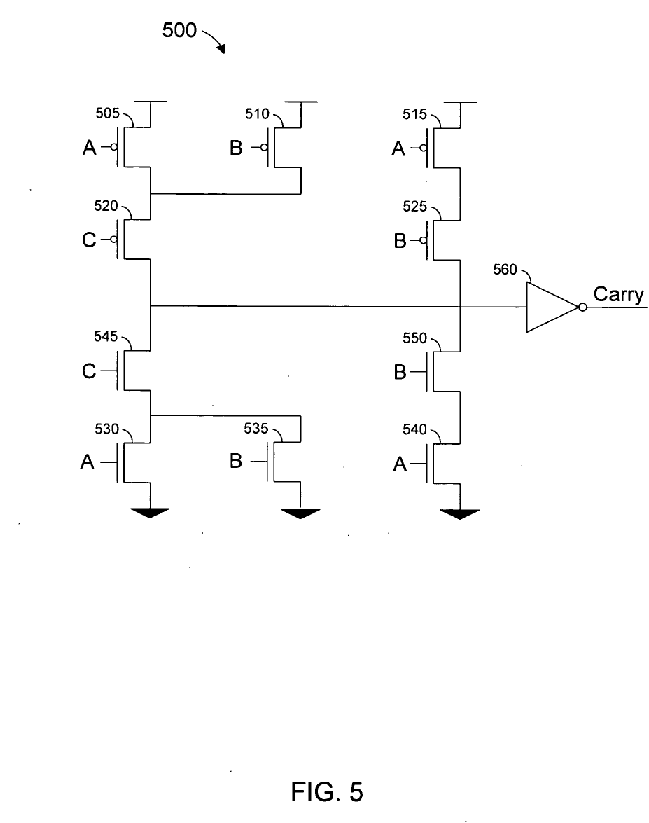

FIG. 5 is a schematic diagram of Carry block 500 according to some embodiments. Carry block 500 is to receive three input bits (e.g., A, B and C) and output a Carry bit, and includes a static mirror. Carry block 500 may be used in conjunction with Sum block 400 to implement compressor 100, and may be used in conjunction with a Sum block of a different design.

Carry block 500 includes p-channel transistors 505 through 525 and n-channel transistors 530 through 550. A source of p-channel transistor 505 is connected to a supply voltage and a gate of p-channel transistor 505 is to receive input bit A. A source of p-channel transistor 510 is connected to the supply voltage, a gate of p-channel transistor 510 is to receive input bit B, and a drain of p-channel transistor 510 is connected to a drain of p-channel transistor 505.

A source of p-channel transistor 515 is connected to the supply voltage and a gate of the p-channel transistor 515 is to receive input bit A, while a source of p-channel transistor 520 is connected to the drain of p-channel transistor 505 and a gate of p-channel transistor 520 is to receive input bit C. Also according to FIG. 5, a source of p-channel transistor 525 is connected to the drain of p-channel transistor 515, a gate of p-channel transistor 525 is to receive input bit B, and a drain of p-channel transistor 525 is connected to a drain of p-channel transistor 520.

N-channel transistors 530 through 550 substantially mirror the layout of p-channel transistors 505 through 525. Specifically, a source of n-channel transistor 530 is connected to ground and a gate of n-channel transistor 530 is to receive input bit A, and a source of n-channel transistor 535 is connected to ground, a gate of n-channel transistor 535 is to receive input bit B, and a drain of n-channel transistor 535 is connected to a drain of n-channel transistor 530. A source of n-channel transistor 540 connected to ground and a gate of n-channel transistor 540 is to receive input bit A.

A source of n-channel transistor 545 is connected to the drain of n-channel transistor 530, a gate of n-channel transistor 545 is to receive input bit C, and a drain of n-channel transistor 545 is connected to a drain of p-channel transistor 520. A source of n-channel transistor 550 is connected to the drain of n-channel transistor 540, a gate of n-channel transistor 550 is to receive input bit B, and a drain of n-channel transistor 550 is connected to a drain of p-channel transistor 525.

Each of the drains of n-channel transistors 545 and 550 and p-channel transistors 520 and 525 are connected to one another and to an input of inverter 560. Inverter 560 outputs the aforementioned Carry bit as shown. According to some embodiments, inverter 560 is omitted and block 500 therefore outputs a Carry# bit. If all inputs are received at substantially the same time, the thusly-modified block 500 would output the Carry# bit approximately 50% faster than block 400 would output the Sum bit. The Carry# signal may therefore be connected to slower inputs of a downstream Sum block to reduce overall delay in a partial product reduction tree.

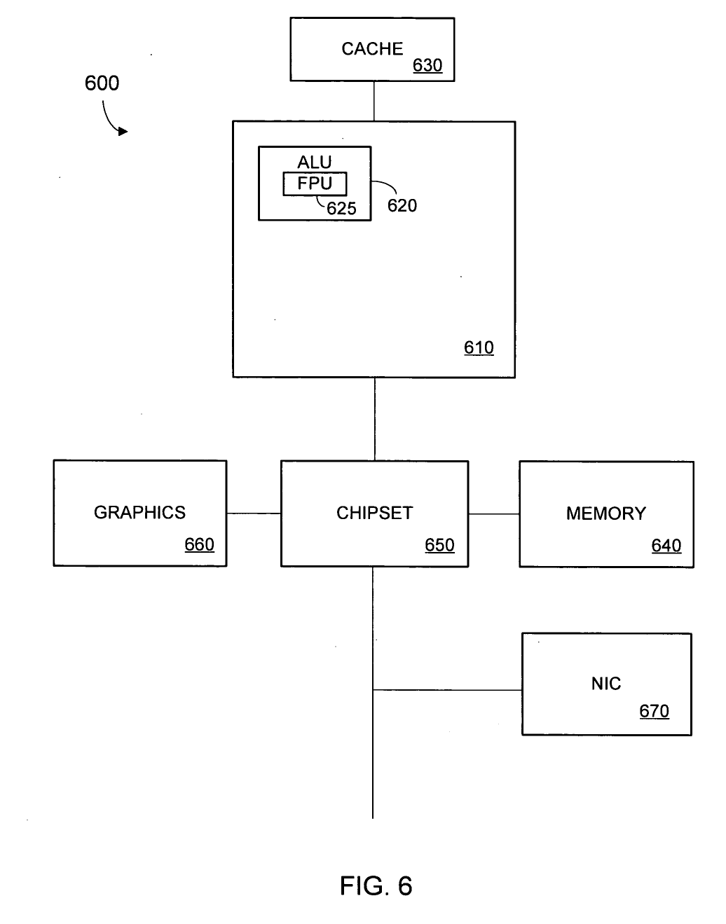

FIG. 6 illustrates a block diagram of system 600 according to some embodiments. System 600 includes integrated circuit 610 which may be a microprocessor or another type of integrated circuit. Integrated circuit 610 includes Arithmetic Logic Unit 620 that in turn includes Floating Point Unit 625. Floating Point Unit 625 may include one or more compressors according to some embodiments described herein. One or more of such compressors may include a first block to receive three input bits, to output a sum bit, and comprising at least one transmission gate, and a second block to receive the three bits, to output a carry bit, and comprising at least one static mirror.

According to some embodiments, integrated circuit 610 also communicates with off-die cache 640. Off-die cache 630 may include registers storing a multiplier or a multiplicand for input to Floating Point Unit 625. Integrated circuit 610 may also communicate with system memory 640 via a host bus and a chipset 650. Memory 640 may comprise any suitable type of memory, including but not limited to Single Data Rate Random Access Memory and Double Data Rate Random Access Memory. In addition, other off-die functional units, such as graphics accelerator 660 and Network Interface Controller (NIC) 670 may communicate with integrated circuit 610 via appropriate busses.

The several embodiments described herein are solely for the purpose of illustration. Therefore, persons in the art will recognize from this description that other embodiments may be practiced with various modifications and alterations.

What is claimed is:

1. A circuit to convert three input bits (A, B and C) to a redundant format, comprising:
a first block comprising at least one transmission gate, the first block to receive the three bits and to output a sum bit; and
a second block comprising at least one static mirror, the second block to receive the three bits and to output a carry bit.

2. A circuit according to claim 1, wherein the sum bit is equal to A XOR B XOR C.

3. A circuit according to claim 1, the first block comprising:
a first transmission gate comprising a first inverted control node, a first non-inverted control node, a first input and a first output, the first inverted control node to receive input bit B, the first non-inverted control node to receive B#, and the first output to receive input bit A;
a second transmission gate comprising a second inverted control node, a second non-inverted control node, a second input and a second output, the second inverted control node to receive B#, the second non-inverted control node to receive input bit B, and the second output connected to the first output;
a third transmission gate comprising a third input to receive input bit C, a third inverted control node, a third non-inverted control node, and a third output; and
a fourth transmission gate comprising a fourth input to receive C#, a fourth inverted control node connected to the third non-inverted control node and to the first input, a fourth non-inverted control node connected to the third inverted control node and to the second input, and a fourth output connected to the third output.

4. A circuit according to claim 3, the second block comprising:
a first p-channel transistor, a source of the first p-channel transistor connected to a supply voltage and a gate of the first p-channel transistor to receive input bit A;
a second p-channel transistor, a source of the second p-channel transistor connected to the supply voltage, a gate of the second p-channel transistor to receive input bit B, and a drain of the second p-channel transistor connected to a drain of the first p-channel transistor;
a third p-channel transistor, a source of the third p-channel transistor connected to the supply voltage and a gate of the third p-channel transistor to receive input bit A;
a fourth p-channel transistor, a source of the fourth p-channel transistor connected to the drain of the first p-channel transistor, and a gate of the fourth p-channel transistor to receive input bit C;
a fifth p-channel transistor, a source of the fifth p-channel transistor connected to the drain of the third p-channel transistor, a gate of the fifth p-channel transistor to receive input bit B, and a drain of the fifth p-channel transistor connected to a drain of the fourth p-channel transistor;
a first n-channel transistor, a source of the first n-channel transistor connected to ground and a gate of the first n-channel transistor to receive input bit A;
a second n-channel transistor, a source of the second n-channel transistor connected to ground, a gate of the second n-channel transistor to receive input bit B, and a drain of the second n-channel transistor connected to a drain of the first n-channel transistor;
a third n-channel transistor, a source of the third n-channel transistor connected to ground and a gate of the third n-channel transistor to receive input bit A;
a fourth n-channel transistor, a source of the fourth n-channel transistor connected to the drain of the first n-channel transistor, a gate of the fourth n-channel transistor to receive input bit C, and a drain of the fourth n-channel transistor connected to a drain of the fourth p-channel transistor; and
a fifth n-channel transistor, a source of the fifth n-channel transistor connected to the drain of the third n-channel transistor, a gate of the fifth n-channel transistor to receive input bit B, and a drain of the fifth n-channel transistor connected to a drain of the fifth p-channel transistor,
wherein the drain of the fifth n-channel transistor, the drain of the fifth p-channel transistor, the drain of the fourth n-channel transistor, and the drain of the fourth p-channel transistor are connected to one another.

5. A circuit according to claim 1, the second block comprising:
a first p-channel transistor, a source of the first p-channel transistor connected to a supply voltage and a gate of the first p-channel transistor to receive input bit A;
a second p-channel transistor, a source of the second p-channel transistor connected to the supply voltage, a gate of the second p-channel transistor to receive input bit B, and a drain of the second p-channel transistor connected to a drain of the first p-channel transistor;
a third p-channel transistor, a source of the third p-channel transistor connected to the supply voltage and a gate of the third p-channel transistor to receive input bit A;
a fourth p-channel transistor, a source of the fourth p-channel transistor connected to the drain of the first p-channel transistor, and a gate of the fourth p-channel transistor to receive input bit C;
a fifth p-channel transistor, a source of the fifth p-channel transistor connected to the drain of the third p-channel transistor, a gate of the fifth p-channel transistor to receive input bit B, and a drain of the fifth p-channel transistor connected to a drain of the fourth p-channel transistor;
a first n-channel transistor, a source of the first n-channel transistor connected to ground and a gate of the first n-channel transistor to receive input bit A;
a second n-channel transistor, a source of the second n-channel transistor connected to ground, a gate of the second n-channel transistor to receive input bit B, and a drain of the second n-channel transistor connected to a drain of the first n-channel transistor;
a third n-channel transistor, a source of the third n-channel transistor connected to ground and a gate of the third n-channel transistor to receive input bit A;
a fourth n-channel transistor, a source of the fourth n-channel transistor connected to the drain of the first n-channel transistor, a gate of the fourth n-channel transistor to receive input bit C, and a drain of the fourth n-channel transistor connected to a drain of the fourth p-channel transistor; and
a fifth n-channel transistor, a source of the fifth n-channel transistor connected to the drain of the third n-channel transistor, a gate of the fifth n-channel transistor to receive input bit B, and a drain of the fifth n-channel transistor connected to a drain of the fifth p-channel transistor,
wherein the drain of the fifth n-channel transistor, the drain of the fifth p-channel transistor, the drain of the fourth n-channel transistor, and the drain of the fourth p-channel transistor are connected to one another.

6. A circuit according to claim 1, further comprising:
a third block comprising at least one transmission gate, the third block to receive at least one of the sum bit and the carry bit and to output a second sum bit; and
a fourth block comprising at least one static mirror, the fourth block to receive at least one of the sum bit and the carry bit and to output a second carry bit.

7. A method to convert three input bits (A, B and C) to a redundant format, comprising:
receiving the three input bits at a first block comprising at least one transmission gate;
outputting a sum bit from the first block based at least on the three input bits;
receiving the three input bits at a second block comprising at least one static mirror;
outputting a carry bit from the second block based at least on the three input bits.

8. A method according to claim 7, wherein the sum bit is equal to A XOR B XOR C.

9. A method according to claim 7, further comprising:
receiving a second three input bits at a third block comprising at least one transmission gate, the second three input bits comprising at least one of the sum bit and the carry bit;
outputting a second sum bit from the third block based at least on the second three input bits;
receiving the second three input bits at a fourth block comprising at least one static mirror;
outputting a second carry bit from the fourth block based at least on the second three input bits.

10. A method according to claim 7, further comprising:
receiving input bit B at a first inverted control node of a first transmission gate of the first block, the first transmission gate comprising a first non-inverted control node, a first input and a first output, the first non-inverted control node to receive B#, and the first output to receive input bit A;
receiving input bit B at a second non-inverted control node of a second transmission gate of the first block, the second transmission gate comprising a second inverted control node, a second input and a second output, the second inverted control node to receive B#, and the second output connected to the first output;
receiving input bit C at a third input of a third transmission gate of the first block, the third transmission gate comprising a third inverted control node, a third non-inverted control node, and a third output; and
receiving C# at a fourth input of a fourth transmission gate of the first block, the fourth transmission gate comprising a fourth inverted control node connected to the third non-inverted control node and to the first input, a fourth non-inverted control node connected to the third inverted control node and to the second input, and a fourth output connected to the third output.

11. A method according to claim 10, further comprising:
receiving input bit A at a gate of a first p-channel transistor of the second block, a source of the first p-channel transistor connected to a supply voltage;
receiving input bit B at a gate of a second p-channel transistor of the second block, a source of the second p-channel transistor connected to the supply voltage, and a drain of the second p-channel transistor connected to a drain of the first p-channel transistor;
receiving input bit A at a gate of a third p-channel transistor of the second block, a source of the third p-channel transistor connected to the supply voltage;
receiving input bit C at a gate of a fourth p-channel transistor of the second block, a source of the fourth p-channel transistor connected to the drain of the first p-channel transistor;
receiving input bit B at a gate of a fifth p-channel transistor of the second block, a source of the fifth p-channel transistor connected to the drain of the third p-channel transistor, and a drain of the fifth p-channel transistor connected to a drain of the fourth p-channel transistor;
receiving input bit A at a gate of a first n-channel transistor of the second block, a source of the first n-channel transistor connected to ground;
receiving input bit B at a gate of a second n-channel transistor of the second block, a source of the second n-channel transistor connected to ground, and a drain of the second n-channel transistor connected to a drain of the first n-channel transistor;
receiving input bit A at a gate of a third n-channel transistor of the second block, a source of the third n-channel transistor connected to ground;
receiving input bit C at a gate of a fourth n-channel transistor of the second block, a source of the fourth n-channel transistor connected to the drain of the first n-channel transistor, and a drain of the fourth n-channel transistor connected to a drain of the fourth p-channel transistor; and
receiving input bit B at a gate of a fifth n-channel transistor of the second block, a source of the fifth n-channel transistor connected to the drain of the third n-channel transistor, and a drain of the fifth n-channel transistor connected to a drain of the fifth p-channel transistor,
wherein the drain of the fifth n-channel transistor, the drain of the fifth p-channel transistor, the drain of the fourth n-channel transistor, and the drain of the fourth p-channel transistor are connected to one another.

12. A method according to claim 7, further comprising:
receiving input bit A at a gate of a first p-channel transistor of the second block, a source of the first p-channel transistor connected to a supply voltage;
receiving input bit B at a gate of a second p-channel transistor of the second block, a source of the second p-channel transistor connected to the supply voltage, and a drain of the second p-channel transistor connected to a drain of the first p-channel transistor;
receiving input bit A at a gate of a third p-channel transistor of the second-block, a source of the third p-channel transistor connected to the supply voltage;
receiving input bit C at a gate of a fourth p-channel transistor of the second block, a source of the fourth p-channel transistor connected to the drain of the first p-channel transistor;
receiving input bit B at a gate of a fifth p-channel transistor of the second block, a source of the fifth p-channel transistor connected to the drain of the third p-channel transistor, and a drain of the fifth p-channel transistor connected to a drain of the fourth p-channel transistor;
receiving input bit A at a gate of a first n-channel transistor of the second block, a source of the first n-channel transistor connected to ground;
receiving input bit B at a gate of a second n-channel transistor of the second block, a source of the second n-channel transistor connected to ground, and a drain of the second n-channel transistor connected to a drain of the first n-channel transistor;
receiving input bit A at a gate of a third n-channel transistor of the second block, a source of the third n-channel transistor connected to ground;
receiving input bit C at a gate of a fourth n-channel transistor of the second block, a source of the fourth n-channel transistor connected to the drain of the first n-channel transistor, and a drain of the fourth n-channel transistor connected to a drain of the fourth p-channel transistor; and
receiving input bit B at a gate of a fifth n-channel transistor of the second block, a source of the fifth n-channel transistor connected to the drain of the third n-channel transistor, and a drain of the fifth n-channel transistor connected to a drain of the fifth p-channel transistor,
wherein the drain of the fifth n-channel transistor, the drain of the fifth p-channel transistor, the drain of the fourth n-channel transistor, and the drain of the fourth p-channel transistor are connected to one another.

13. A system comprising:
a processor comprising a circuit to convert three input bits (A, B and C) to a redundant format, the circuit comprising:
a first block comprising at least one transmission gate, the first block to receive the three bits and to output a sum bit; and
a second block comprising at least one static mirror, the second block to receive the three bits and to output a carry bit; and
a double data rate memory coupled to the processor.

14. A system according to claim 13, wherein the sum bit is equal to A XOR B XOR C.

15. A system according to claim 13, the first block comprising:
a first transmission gate comprising a first inverted control node, a first non-inverted control node, a first input and a first output, the first inverted control node to receive input bit B, the first non-inverted control node to receive B#, and the first output to receive input bit A;
a second transmission gate comprising a second inverted control node, a second non-inverted control node, a second input and a second output, the second inverted control node to receive B#, the second non-inverted control node to receive input bit B, and the second output connected to the first output;
a third transmission gate comprising a third input to receive input bit C, a third inverted control node, a third non-inverted control node, and a third output; and
a fourth transmission gate comprising a fourth input to receive C#, a fourth inverted control node connected to the third non-inverted control node and to the first input, a fourth non-inverted control node connected to the third inverted control node and to the second input, and a fourth output connected to the third output.

16. A system according to claim 15, the second block comprising:
a first p-channel transistor, a source of the first p-channel transistor connected to a supply voltage and a gate of the first p-channel transistor to receive input bit A;
a second p-channel transistor, a source of the second p-channel transistor connected to the supply voltage, a gate of the second p-channel transistor to receive input bit B, and a drain of the second p-channel transistor connected to a drain of the first p-channel transistor;
a third p-channel transistor, a source of the third p-channel transistor connected to the supply voltage and a gate of the third p-channel transistor to receive input bit A;
a fourth p-channel transistor, a source of the fourth p-channel transistor connected to the drain of the first p-channel transistor, and a gate of the fourth p-channel transistor to receive input bit C;
a fifth p-channel transistor, a source of the fifth p-channel transistor connected to the drain of the third p-channel transistor, a gate of the fifth p-channel transistor to receive input bit B, and a drain of the fifth p-channel transistor connected to a drain of the fourth p-channel transistor;
a first n-channel transistor, a source of the first n-channel transistor connected to ground and a gate of the first n-channel transistor to receive input bit A;
a second n-channel transistor, a source of the second n-channel transistor connected to ground, a gate of the second n-channel transistor to receive input bit B, and a drain of the second n-channel transistor connected to a drain of the first n-channel transistor;
a third n-channel transistor, a source of the third n-channel transistor connected to ground and a gate of the third n-channel transistor to receive input bit A;
a fourth n-channel transistor, a source of the fourth n-channel transistor connected to the drain of the first n-channel transistor, a gate of the fourth n-channel transistor to receive input bit C, and a drain of the fourth n-channel transistor connected to a drain of the fourth p-channel transistor; and
a fifth n-channel transistor, a source of the fifth n-channel transistor connected to the drain of the third n-channel transistor, a gate of the fifth n-channel transistor to receive input bit B, and a drain of the fifth n-channel transistor connected to a drain of the fifth p-channel transistor,
wherein the drain of the fifth n-channel transistor, the drain of the fifth p-channel transistor, the drain of the fourth n-channel transistor, and the drain of the fourth p-channel transistor are connected to one another.
